(19) United States
(12) Patent Application Publication
(10) Pub. No.: US 2009/0226708 A1
(43) Pub. Date: Sep. 10, 2009

(54) PRESSURE-SENSITIVE ADHESIVE COMPOSITION AND PRESSURE-SENSITIVE ADHESIVE SHEET

(75) Inventors: Satoshi NAGANAWA, Satoshi (JP); Mikihiro Kashio, Itabashi-ku (JP)

Correspondence Address: SUGHRUE MION, PLLC, 2100 PENNSYLVANIA AVENUE, N.W., SUITE 800, WASHINGTON, DC, 20037, US

(73) Assignee: LINTEC Corporation, Tokyo (JP)

(21) Appl. No.: 12/396,902

(22) Filed: Mar. 3, 2009

(30) Foreign Application Priority Data
Mar. 4, 2008 (JP) 2008-053786
Dec. 18, 2008 (JP) 2008-323002

(51) Int. Cl. C09J 7/02; B32B 5/16; C09J 11/04; B82B 1/00

(52) U.S. Cl. 428/323; 524/495; 522/71; 977/778

(57) ABSTRACT

The present invention provides a pressure-sensitive adhesive composition, which comprises a pressure-sensitive adhesive, a carbon nano material and a dispersing agent, the carbon nano material being dispersed with the dispersing agent in the pressure-sensitive adhesive, and a pressure-sensitive adhesive sheet, which comprises a substrate sheet and a pressure-sensitive adhesive layer composed of the pressure-sensitive adhesive composition of the present invention, the pressure-sensitive adhesive layer being formed on one surface or both surfaces of the substrate sheet. The pressure-sensitive adhesive composition and the pressure-sensitive adhesive sheet are superior in the antistatic property or the conductive property.

### TECHNICAL FIELD

The present invention relates to a pressure-sensitive adhesive composition and a pressure-sensitive adhesive sheet. Specifically, the present invention relates to a pressure-sensitive adhesive composition having an antistatic property or a conductive property and a pressure-sensitive adhesive sheet having a pressure-sensitive adhesive layer composed of the pressure-sensitive adhesive composition which can be utilized for a semiconductor wafer processing and the other things.

### BACKGROUND ART

Conventionally, when electrical parts, electronic parts and semiconductor parts have been produced, for the purpose of fixing the parts and protecting the circuit and the other things in a treatment process such as dicing, a pressure-sensitive adhesive tape has been used.

Such pressure-sensitive adhesive tape includes a pressure-sensitive adhesive tape in which a removable acrylic pressure-sensitive adhesive layer is formed on a substrate film, and a pressure-sensitive adhesive tape formed with a photocrosslinkable type removable pressure-sensitive adhesive layer which has strong peeling resistance in the treatment process after sticking, but can be peeled off by small power when the pressure-sensitive adhesive tape is peeled off.

The pressure-sensitive adhesive tapes are peeled off after the prescribed treatment processes. At the peeling, static electricity called as “peeling static electrification” is generated between the part and the pressure-sensitive adhesive tape. For inhibiting a bad influence caused by the static electrification to an adherend (for example, breaking of circuit), a pressure-sensitive adhesive tape in which an antistatic treatment is provided on the back surface of the substrate film, a pressure-sensitive adhesive tape in which an antistatic agent is added and mixed in the pressure-sensitive adhesive layer, and a pressure-sensitive adhesive tape in which an antistatic middle layer is formed between the substrate film and the pressure-sensitive adhesive layer, have been used.

But, if the substrate in the part for forming the circuit is an insulating material such as ceramics and glasses, the generated quantity of the static electricity is large, and it takes a lot of time to do the attenuation. In such case, even if the pressure-sensitive adhesive tape described above is used, the effect of the antistatic property is insufficient, and there is large possibility that the circuit is broken. Therefore, in the production process of the part described above, for example, the generation of the static electricity in an ambient environment is actually suppressed by using further an static electricity removing device such as ionizer.

However, there has been a problem that even if adopting the countermeasure described above, the sufficient antistatic effect can be not obtain, the productivity is low, and the protective action is also insufficient.

Also, it has been regarded that in order to prevent the peeling static electrification of the pressure-sensitive adhesive tape, it is effective to provide the treatment on the side of the pressure-sensitive adhesive, rather than providing the treatment on the side of substrate film. As the conventional antistatic pressure-sensitive adhesive, in general, antistatic pressure-sensitive adhesives in which conductive materials such as copper powder, silver powder, nickel powder and aluminum powder are dispersed in the pressure-sensitive adhesive, has been utilized in many uses.

However, if the large amount of the conductive material is contained in such antistatic pressure-sensitive adhesive to increase the interaction contact of the conductive material particles for obtaining the superior conductive property, the adhesive strength decreases. On the other hand, if the content of the conductive material is decreased in such antistatic pressure-sensitive adhesive to increase the adhesive strength, the above-described contacts are insufficient and the conductive property decreases. Thus, there has been an antinomy problem.

Against the problem, a pressure-sensitive adhesive tape in which the conductive pressure-sensitive adhesive obtained by mixing any one or both of carbon nano tubes and carbon micro coils in the pressure-sensitive adhesive is applied on a fabric metalized by vapor deposition, has been suggested (see the patent reference of JP2001-172582).

However, in the pressure-sensitive adhesive tape described above in the patent reference, the base material (support) layer is a fabric metalized by vapor deposition. Accordingly, the conductive pressure-sensitive adhesive is not adapted to resin film materials used as base material in commodity pressure-sensitive adhesive tapes. Therefore, there is a possibility that the conductive property is not exerted sufficiently by using the resin film as the base material layer.

Further, since the carbon nano tube has a strong aggregation property, there has been a problem that even if the carbon nano tube is mixed alone in the resin, the sufficient dispersion is not maintained and the property of the carbon nano tube is not exerted sufficiently.

### DISCLOSER OF THE INVENTION

The present invention is provided as the result of considering the situation of the conventional technologies described above.

An object of the present invention is to provide a pressure-sensitive adhesive composition having a superior antistatic property or a superior conductive property, and a pressure-sensitive adhesive sheet having a pressure-sensitive adhesive layer composed of the pressure-sensitive adhesive composition.

Another object of the present invention is to provide a cured pressure-sensitive adhesive composition having a superior antistatic property or a superior conductive property after curing, when the pressure-sensitive adhesive composition is cured by irradiating an energy ray, and a pressure-sensitive adhesive sheet thereof.

The present inventors have perfected the present invention by discovering that a carbon nano material is dispersed with a dispersing agent in the pressure-sensitive adhesive and the above-described problems can be solved by thereof.

Specifically, the present invention provides a pressure-sensitive adhesive composition, which comprises a pressure-sensitive adhesive, a carbon nano material and a dispersing agent, the carbon nano material being dispersed with the dispersing agent in the pressure-sensitive adhesive.

Additionally, the present invention provides the pressure-sensitive adhesive composition as described above, wherein the carbon nano material has an average peripheral size of 1 to 1,000 nm and an average length of 10 nm to 100 μm.

Additionally, the present invention provides the pressure-sensitive adhesive composition as described above, wherein the dispersing agent is a polymer having an ether skeleton structure.

Further, the present invention provides the pressure-sensitive adhesive composition as described above, wherein the pressure-sensitive adhesive composition comprises further an energy ray polymerizable group-containing compound.

Furthermore, the present invention provides the pressure-sensitive adhesive composition as described above, wherein the pressure-sensitive adhesive composition comprises furthermore a photopolymerization initiator.

Also, the present invention provides the pressure-sensitive adhesive composition as described above, wherein the carbon nano material is comprised in the ratio of 0.05 to 15% by mass in a solid content of the pressure-sensitive adhesive composition.

Further, the present invention provides a pressure-sensitive adhesive sheet, which comprises a substrate sheet and a pressure-sensitive adhesive layer composed of the pressure-sensitive adhesive composition as described above, the pressure-sensitive adhesive layer being formed on one surface or both surfaces of the substrate sheet.

Furthermore, the present invention provides the pressure-sensitive adhesive sheet as described above, wherein the pressure-sensitive adhesive sheet is a pressure-sensitive adhesive sheet for a semiconductor wafer processing.

### EFFECT OF THE INVENTION

The pressure-sensitive adhesive composition of the present invention has a superior antistatic property or a superior conductive property. When the pressure-sensitive adhesive composition is cured by irradiating an energy ray, the cured pressure-sensitive adhesive composition has also a superior antistatic property or a superior conductive property after curing.

Further, if the pressure-sensitive adhesive sheet of the present invention is stuck to the adherend such as semiconductor wafer, the pressure-sensitive adhesive sheet has a superior antistatic property or a superior conductive property. When the pressure-sensitive adhesive sheet is cured by irradiating an energy ray, the cured pressure-sensitive adhesive sheet has also a superior antistatic property or a superior conductive property after curing. Therefore, the production of the semiconductor and the other things can be conducted more efficiently.

### Preferred Embodiments for Carrying Out the Invention

The pressure-sensitive adhesive composition of the present invention comprises a pressure-sensitive adhesive, a carbon nano material and a dispersing agent. The carbon nano material are dispersed homogeneously with the dispersing agent in the pressure-sensitive adhesive. In the present invention, the term of “the homogeneous dispersion” means a state that the carbon nano material is dispersed without aggregation by visual in the pressure-sensitive adhesive composition and the pressure-sensitive adhesive layer formed by using the pressure-sensitive adhesive composition. The homogeneous dispersion of the carbon nano material exerts the superior antistatic property or the superior conductive property. In the present invention, the term of “the having of the antistatic property” means that a surface resistivity is less than 10¹³ Ω/□, and the term of “the having of the conductive property” means that a surface resistivity is less than 10⁸ Ω/□. In the case that the pressure-sensitive adhesive composition contains the energy ray polymerizable group-containing compound, if the surface resistivity before curing and/or after curing of the pressure-sensitive adhesive composition is in the range described above, the pressure-sensitive adhesive composition means the having of the antistatic property or the having of the conductive property.

The pressure-sensitive adhesive can be a water soluble pressure-sensitive adhesive, or organic solvent soluble pressure-sensitive adhesive.

The pressure-sensitive adhesive includes, for example, natural rubber-based pressure-sensitive adhesives, synthetic rubber-based pressure-sensitive adhesives, acrylic resin-based pressure-sensitive adhesives, polyvinylether resin-based pressure-sensitive adhesives, urethane resin-based pressure-sensitive adhesives and silicone resin-based pressure-sensitive adhesives. Specific examples of the synthetic rubber-based pressure-sensitive adhesives include styrene-butadiene rubber, isobutylene-isoprene rubber, polyisobutylene rubber, polyisoprene rubber, styrene-isoprene block copolymer, styrene-butadiene block copolymer, styrene-ethylene-butylene block copolymer and ethylene-vinyl acetate thermoplastic elastomer.

Specific examples of the acrylic resin-based pressure-sensitive adhesives include acrylic resin-based pressure-sensitive adhesives which comprise a (meth)acrylic ester copolymer as a base resin. The (meth)acrylic ester copolymer includes copolymers of one or more monomers of alkyl (meth)acrylic alkyl ester such as methyl acrylate, ethyl acrylate, propyl acrylate, butyl acrylate, 2-ethylhexyl acrylate, methyl methacrylate, ethyl methacrylate, propyl methacrylate and butyl methacrylate; and optionally one or more monomers selected from copolymerizable monomers of hydroxy group-containing (meth)acrylic alkyl esters such as 2-hydroxyethyl acrylate, 2-hydroxypropyl acrylate, 3-hydroxypropyl acrylate, 3-hydroxybutyl acrylate and 4-hydroxybutyl acrylate, 2-hydroxyethyl methacrylate, 2-hydroxypropyl methacrylate, 3-hydroxypropyl methacrylate, 3-hydroxybutyl methacrylate and 4-hydroxybutyl methacrylate; (meth)acrylic acids such as acrylic acid and methacrylic acid; vinyl esters such as vinyl acetate and vinyl propionate; cyano group-containing compounds such as acrylonitrile and methacrylonitrile; amido group-containing compounds such as acrylamide and aromatic compounds such as styrene and vinylpyridine.

The content of the unit based on a (meth)acrylic ester in the (meth)acrylic ester copolymer is preferably 50 to 98% by mass, more preferably 60 to 95% by mass, most preferably 70 to 93% by mass.

The weight average molecular weight of (meth)acrylic ester copolymer is preferably 300,000 to 2,500,000, more preferably 400,000 to 1,500,000, and particularly preferably 450,000 to 1,000,000.

In the specification of the present application, the term of “weight average molecular weight” means a value converted to standard polystyrene measured by gel permeation chromatography method.

Specific examples of the polyvinylether resin-based pressure-sensitive adhesives include pressure-sensitive adhesives which comprise a polyvinylethylether or a polyvinylisobutylether as a base resin. Specific examples of the urethane resin-based pressure-sensitive adhesives include pressure-sensitive adhesives which comprise a reaction product of a polyol and a cyclic or chain isocyanate as base resin, and an additive such as tackifire and plasticizer. Specific examples of the silicone resin-based pressure-sensitive adhesives include pressure-sensitive adhesives which comprise dimethylpolysiloxane as base resin. These pressure-sensitive adhesives can be used each alone or in combinations of two or more members.

Preferred among these pressure-sensitive adhesives are the acrylic resin-based pressure-sensitive adhesives. Particularly preferred are acrylic resin-based pressure-sensitive adhesives obtained by crosslinking acrylic copolymers with one or more of crosslinking agents such as polyisocyanate based crosslinking agents, epoxy based crosslinking agents, aziridine based crosslinking agents, and chelate based crosslinking agents.

Examples of the polyisocyanate based crosslinking agent include tolylene diisocyanate (TDI), hexamethylene diisocyanate (HMDI), isophorone diisocyanate (IPDI), xylylene diisocyanate (XDI), hydrogenated tolylene diisocyanate, diphenylmethane diisocyanate and the hydrogenated product thereof, polymethylenepolyphenyl polyisocyanate, naphthylene-1,5-diisocyanate, polyisocyanate prepolymer and polymethylolpropane modified TDI.

Examples of the epoxy based crosslinking agents include ethylene glycol diglycidyl ether, 1,6-hexane diol diglycidyl ether, trimethylol propane diglycidyl ether, diglycidyl aniline and diglycidyl amine. Examples of the aziridine based crosslinking agents include 2,2-bishydroxymethyl butanol-tris[3-(1-aziridinyl)propionate], 4,4-bis(ethylene imino carboxyamino)diphenyl methane, tris-2,4,6-(1-aziridinyl)-1,3,5-triazine, tris[1-(2-methyl)aziridinyl]phosphine oxide and hexa[1-(2-methyl)aziridinyl]triphospha triazine. Examples of the chelate based crosslinking agents include aluminum chelate and titanium chelate.

The crosslinking agents can be used each alone or in combinations of two or more members.

The use amount of the crosslinking agents is preferably 0.01 to 20 parts by mass relative to 100 parts by mass of the acrylic copolymer.

When curing the pressure-sensitive adhesive composition of the present invention by irradiating the energy ray, an energy ray curable pressure-sensitive adhesive comprising an energy ray polymerizable group-containing compound in the pressure-sensitive adhesive composition is used.

The energy ray polymerizable group-containing compound includes, for example, a base resin of energy ray polymerizable group-containing adhesive, and an energy ray polymerizable group-containing monomer and oligomer.

Examples of the base resin of energy ray polymerizable group-containing adhesive include a base resin which is obtained by addition reacting the (meth)acrylic ester copolymer with a compound having in a molecule the energy ray polymerizable group and a functional group which can react with the hydroxyl group or carboxyl group (for example, acrylic acid and the like) in the (meth)acrylic ester copolymer described before. Examples of such compound include 2-methacryloyl oxyethyl isocyanate and grycidyl methacrylate.

Examples of the energy ray polymerizable group-containing monomer and oligomer, which is comprised in the energy ray curable pressure-sensitive adhesive, include, for example, polyfunctional energy ray curable acrylic compounds having two or more functional groups such as polyfunctional acrylates, urethane acrylates and polyester acrylates. Among them, the urethane acrylate oligomer and the polyester acrylate oligomer are preferable, and the urethane acrylate oligomer is more preferable.

Examples of polyfunctional acrylates include ethylene glycol di(meth)acrylate, propylene glycol di(meth)acrylate, butylene glycol di(meth)acrylate, neopentyl glycol di(meth)acrylate, hexane diol di(meth)acrylate, trimethylol ethane tri(meth)acrylate, trimethylol propane tri(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, triallyl(meth)acrylate, and bisphenol A ethyleneoxide modified di(meth)acrylate.

The urethane acrylate oligomer is obtained, for example, by esterifying a (meth)acrylic acid with the hydroxyl group of the polyurethane oligomer prepared by reacting a polyether polyol or a polyester polyol with a polyisocyanate. Also, the urethane acrylate oligomer is obtained by reacting a hydroxyl group-containing (meth)acrylate with end isocyanate group-containing polyurethane oligomer prepared by reacting a polyether polyol or a polyester polyol with a polyisocyanate. Examples of the polyisocyanate include 2,4-tolylene diisocyanate, 2,6-tolylene diisocyanate, 1,3-xylylene diisocyanate, 1,4-xylylene diisocyanate, diphenylmethane-4,4-diisocyanate. Also, examples of the hydroxyl group-containing (meth)acrylate include 2-hydroxyethyl acrylate, 2-hydroxyethyl methacrylate, 2-hydroxypropyl acrylate, and 2-hydroxypropyl methacrylate.

The polyester acrylate oligomer is obtained, for example, by esterifying the (meth)acrylic acid with the hydroxyl group of the polyester oligomer having hydroxyl groups in both ends prepared by condensating a polcarboxylic acid with a polyhydric alcohol, or is obtained by esterifying the (meth)acrylic acid with the end hydroxyl group of the oligomer prepared by addition reacting a polcarboxylic acid with an alkylene oxide.

The molecular weight (weight average molecular weight) of the energy ray polymerizable group-containing oligomer is preferably 1,000 to 100,000. particularly, the molecular weight of the urethane acrylate oligomer is preferably 1,000 to 50,000, and more preferably 2,000 to 30,000.

The energy ray polymerizable group-containing monomer and/or oligomer can be used each alone or in combinations of two or more members.

The content of the energy ray polymerizable group-containing monomer and/or oligomer is particularly not limited, but preferably 5 to 80% by mass and more preferably 15 to 60% by mass in the solid content of the pressure-sensitive adhesive composition.

The term “solid content” means components except for components removed by drying, when forming the pressure-sensitive adhesives layer. Specifically, the solid content means components except for the solvents and dispersion mediums mentioned after.

The energy ray includes ultraviolet ray, electron beam, α-ray, β-ray and γ-ray. When the ultraviolet ray is used, the curable composition comprises preferably a photopolymerization initiator. The photopolymerization initiator includes conventional photopolymerization initiators such as acetophenone based compounds such as 2-methyl-1-[4-(methylthio)phenyl]-2-morphorinopropane-1-one, methoxy acetophenone, 2,2-dimethoxy-2-phenylacetophenone and 2,2-diethoxy acetophenone; benzophenone based compounds such as benzophenone, benzoyl benzoic acid and 3,3′-dimethyl-4-methoxy benzophenone; benzoin ether based compounds such as benzoin ethyl ether, benzoin isopropyl ether and anisoin methyl ether; ketal based compounds such as benzyl dimethyl ketal; aromatic sulfonyl chloride based compounds such as 2-naphthalene sulfonyl chloride; photoacitive oxyme based compounds such as 1-phenone-1,1-propanedion-2-(o-ethoxycarbonyl)oxyme. Also, oligomer type photopolymerization initiators can be utilized.

The photopolymerization initiator can be used each alone or in combinations of two or more members.

The formulation amount of the photopolymerization initiator is preferably 0.1 to 15 parts by mass, more preferably 0.2 to 10 parts by mass and most preferably 0.5 to 5 parts by mass relative to 100 parts by mass of the energy ray polymerizable group-containing compound.

The carbon nano material has an average peripheral size of preferably 1 to 1,000 nm, more preferably 2 to 100 nm, most preferably 3 to 50 nm, and an average length of preferably 10 nm to 100 μm, more preferably 10 nm to 50 μm, most preferably 100 nm to 30 μm.

The average peripheral size is the average value of the measurement values obtained by measuring random 100 points of the carbon nano material by using an electron microscope. The average length is the average value of the measurement values obtained by measuring random 100 points of the carbon nano material by using an electron microscope. Also, the measurement of the average peripheral size is conducted at the center section in the length direction of the carbon nano material.

If the shape of the carbon nano material is a cylindrical shape having a cross sectional form of concentric circle, the peripheral size means an outer circumference diameter.

The ratio of the average length to the average peripheral size of the carbon nano material is preferably 100 to 5,000, more preferably 200 to 3,000.

Examples of the carbon nano material include, for example, carbon nano coils, single layer or multiple layers carbon nano tubes. Among them, the single layer or multiple layers carbon nano tubes are preferable, and multiple layers carbon nano tubes are more preferable.

The carbon nano coil has an average peripheral size of preferably 10 to 100 nm, more preferably 10 to 50 nm, most preferably 15 to 40 nm, and an average length of preferably 10 nm to 100 μm, more preferably 10 nm to 50 μm, most preferably 15 nm to 30 μm. The ratio of the average length to the average peripheral size of the carbon nano coil is preferably 200 to 5,000, more preferably 300 to 3,000.

The single layer carbon nano tube has an average peripheral size of preferably 1 to 10 nm, more preferably 1 to 8 nm, most preferably 2 to 7 nm, and an average length of preferably 10 nm to 100 μm, more preferably 10 nm to 50 μm, preferably 12 nm to 30 μm. The ratio of the average length to the average peripheral size of the single layer carbon nano tube is preferably 1,000 to 5,000, more preferably 1,000 to 3,000.

The multiple layers carbon nano tube has an average peripheral size of preferably 10 to 100 nm, more preferably 10 to 50 nm, most preferably 10 to 30 nm, and an average length of preferably 10 nm to 100 μm, more preferably 10 nm to 50 μm, preferably 10 nm to 30 μm. The ratio of the average length to the average peripheral size of the multiple layers carbon nano tube is preferably 200 to 5,000, more preferably 300 to 3,000.

The shape of the carbon nano coil can be a cylindrical and hollow fiber shape or a fiber shape without hollow. The end shape of the carbon nano coil is not needed to be the cylindrical shape necessarily. For example, the end shape of the carbon nano coil can be deformation such as cone. Further, the end shape of the carbon nano coil can be a closed structure, or an opened structure. Also, the shape of the carbon nano tube is usually cylindrical and hollow fiber shape. But, the end shape of the carbon nano tube is not needed to be the cylindrical shape necessarily. For example, the end shape of the carbon nano tube can be deformation such as cone. Further, the end shape of the carbon nano tube can be a closed structure, or an opened structure.

The commercial product of the carbon nano tube includes preferably a product of trade name “CVD-MWNT CM-95” manufactured by IRDINE NANOTECHNOLOGY CORPORATION.

The content of the carbon nano material is preferably 0.05 to 15% by mass, more preferably 0.5 to 10% by mass in the solid content of the pressure-sensitive adhesive composition.

The dispersing agent can be a water soluble dispersing agent, or an organic solvent soluble dispersing agent. When the dispersion medium mentioned after is an aqueous dispersion medium, the water soluble dispersing agent is preferable. When the dispersion medium mentioned after is an organic solvent, the organic solvent soluble dispersing agent is preferable.

The dispersing agent is preferably a polymer having an ether skeleton structure. Examples of the polymer include an anionic polyether such as carboxyl group-containing polyethers, a cationic polyether such as amino group-containing polyethers, and a nonionic polyether. The polyether skeleton structure includes skeleton structures having polyoxyalkylene group, and specifically, polyoxyalkylene homopolymers such as polyethylene ether, polypropylene ether and polybutylene ether; and polyoxyalkylene copolymers having two or more alkylene oxide groups such as ethylene oxide group, propylene oxide group and butylene oxide group. Among them, the nonionic polyether is preferable.

The weight average molecular weight of the dispersing agent is particularly not limited, but preferably 1,000 to 100,000, more preferably 5,000 to 70,000.

The commercial product of the nonionic polyether includes preferably a product of trade name “FLOWLEN NC-500” manufactured by Kyoeisha Chemical Co., Ltd.

The content of the dispersing agent is preferably 50 to 1,000 parts by mass, more preferably 60 to 500 parts by mass, relative to 100 parts by mass of the carbon nano material.

In order to disperse homogeneously the carbon nano material with the dispersing agent in the pressure-sensitive adhesive, a method which comprises mixing the pressure-sensitive adhesive, the carbon nano material and the dispersing agent in the dispersion medium to obtain a dispersion liquid of the pressure-sensitive adhesive, and then, stirring the dispersion liquid of the pressure-sensitive adhesive is preferable.

The stirring can be conducted by the conventional stirring methods. In particular, the stirring by applying a ultrasonic vibration is preferable. The stirring time is not particularly limited, but usually preferably 0.5 to 5 hours.

In order to disperse more homogeneously the carbon nano material with the dispersing agent in the pressure-sensitive adhesive, a method which comprises mixing preliminarily the carbon nano material and the dispersing agent in the dispersion medium to prepare a dispersion liquid of the carbon nano material, and then, mixing the dispersion liquid of the carbon nano material in the pressure-sensitive adhesive, is preferable.

The dispersion medium includes aqueous solvents and organic solvents. The organic solvents are preferable.

The organic solvents include alcohols such as isobutanol and isopropanol; aromatic hydrocarbons such as benzene, toluene and xylene; aliphatic hydrocarbons such as hexane, heptane, octane, nonane and decane; esters such as ethyl acetate and butyl acetate; ketones such as methyl ethyl ketone, diethyl ketone and diisopropyl ketone; cellosolve solvents such as ethyl cellosolve; and glycol ether solvents such as propylene glycol monomethyl ether. Among them, the aromatic solvent is preferable.

In this case, the content of the carbon nano material in the dispersion liquid of the carbon nano material is preferably 0.05 to 3% by mass, more preferably 0.1 to 2.5% by mass and most preferably 0.2 to 2.3% by mass.

In this case, the dispersion liquid of the carbon nano material is preferable to disperse the carbon nano material homogeneously by stirring. The stirring can be conducted by conventional stirring methods, but particularly, it is preferable to stir by applying a ultrasonic vibration. The stirring time is not particularly limited, but usually preferably 0.5 to 5 hours.

When mixing the dispersion liquid of the carbon nano material in the pressure-sensitive adhesive, the pressure-sensitive adhesive is preferable to be a state of the dispersion liquid or the solution of the pressure-sensitive adhesive in which the pressure-sensitive adhesive is dispersed or dissolved in the solvent or the energy ray polymerizable group-containing monomer and/or oligomer.

The solvent includes aqueous solvents and organic solvents. The organic solvents are preferable, when the pressure-sensitive adhesive composition is applied and then dried.

The organic solvents include the same solvents in the dispersion medium as described above. Among them, the aromatic solvent is preferable. The formulation amount of the solvent can be selected properly to be the required viscosity.

As the substrate sheet in the pressure-sensitive adhesive sheet of the present invention, sheets and films of various plastics can be utilized.

Examples of the substrate sheet includes sheets or films of various synthetic resins of polyolefin resins such as polyethylene resin and polypropylene resin; polyester resins such as polyethylene terephthalate resin, polyethylene naphthalate resin and polybutylene terephthalate resin; polyvinyl chloride resins; polystyrene resins; polyurethane resin; polycarbonate resins; polyamide resins; polyimide resins; fluorine resins and the like. In view of high strength and cheap cost, sheets or films of polyester resins such as polyethylene terephthalate resin are preferable. The substrate sheet can be a single layer or a multiple layers having two or more layers of the same type or different types.

When the energy ray curable pressure-sensitive adhesive is used as the pressure-sensitive adhesive, an energy ray transmitable substrate sheet is preferable.

No particular constraint is imposed on the thickness of the substrate sheet; however, usually the thickness falls preferably within a range from 10 to 350 μm, more preferably within a range from 25 to 300 μm and particularly preferably within a range from 50 to 250 μm.

On the surface of the substrate sheet, a treatment for improving adhesion can be provided. The treatment for improving adhesion is not limited particularly, but includes, for example, corona discharge treatment.

In the pressure-sensitive adhesive sheet of the present invention, the pressure-sensitive adhesive layer composed of pressure-sensitive adhesive composition described above is formed on one surface or both surfaces of the substrate sheet.

No particular constraint is imposed on the thickness of pressure-sensitive adhesive layer; however, usually the thickness falls preferably within a range from 3 to 150 μm, more preferably within a range from 5 to 100 μm and particularly preferably within a range from 10 to 60 μm.

The formation of the pressure-sensitive adhesive layer on one surface or both surfaces of the substrate sheet can be carried out by applying the pressure-sensitive adhesive described above on one surface or both surfaces of the substrate sheet and optionally drying.

Examples of application method of the pressure-sensitive adhesive composition described above on the substrate sheet include conventional methods, for example, such as a bar coating method, an knife coating method, a roll coating method, a blade coating method, a die coating method, a gravure coating method and a curtain coating method.

The drying is preferable to carry out usually at 20 to 150° C.

The pressure-sensitive adhesive sheet of the present invention is not limited in the uses and can be used in various field, so long as the pressure-sensitive adhesive sheet is stuck to the adherend in fields wherein the antistatic property or the conductive property are required.

The pressure-sensitive adhesive sheet of the present invention can be utilized in the use that the energy ray is not irradiated after sticking the pressure-sensitive adhesive sheet to the adherend, and also, can be utilized in the use that after the pressure-sensitive adhesive sheet is stuck to the adherend and fed in the treatment process, the pressure-sensitive adhesive sheet is irradiated by the energy ray to decrease the adhesive strength and then, is peeled off from the adherend to remove. The later uses include, for example, dicing sheets for semiconductor wafer and the like, which is used to stick on the back surface of the semiconductor wafer to hold the wafer in a dicing process wherein the formed element is cut and divided in small pieces during the semiconductor wafer is fixed by sticking and then, the small elements are automatically recovered by a method of pickup, and surface protecting sheets for semiconductor wafer and the like, which is utilized to protect the surface of the semiconductor wafer in the process for grinding the back surface of the semiconductor wafer.

As the irradiated energy ray, energy rays generated from various energy ray generating devices can be used. For example, as the ultraviolet ray, ultraviolet ray radiated from an ultraviolet lamp is usually utilized. As the ultraviolet ray lamp, ultraviolet ray lamp such as high-pressure mercury lamp, fusion H lamp and xenon lamp which can generate ultraviolet ray having spectrum distribution within the region of wavelength of 300 to 400 nm. Usually, the quantity of the irradiation is preferably 50 to 3,000 mJ/cm².

### EXAMPLES

Hereinafter, specific description will be made on the present invention with reference to Examples. However, the present invention is not limited at all by these Examples.

### Example 1

(1) Preparation of a Dispersion Liquid of Carbon Nano Tube

A multiple layers carbon nano tube (a product of trade name “CVD-MWNT CM-95” manufactured by IRDINE NANOTECHNOLOGY CORPORATION, cylindrical and hollow fiber shape, average outer circumference diameter of 12 nm, average length of 15 μm, ratio of the average length to the average outer circumference diameter of 1250) and a nonionic polyether dispersing agent having a polyoxyalkylene group (a product of trade name “FLOWLEN NC-500” manufactured by Kyoeisha Chemical Co., Ltd.) were added in toluene in each same amount, and then, dispersed by applying ultrasonic vibration for 2 hours by utilizing a ultrasonic washing machine (42 kHz, 125W) to prepare a carbon nano tube-dispersing toluene solution, wherein the concentrations of the carbon nano tube and the dispersing agent are each 2% by mass in the dispersing toluene solution. The values of the average outer circumference diameter and the average length were measured by observing each in 50,000 magnifications and 15,000 magnifications by using a scanning type electron microscope (a product of trade name “S-4700” manufactured by Hitachi High-Technologies Corporation)

(2) Preparation of a Pressure-Sensitive Adhesive Composition

A mixture liquid was prepared by adding 10 parts by mass of an isocyanate-based crosslinking agent (trade name “olibain BHS8515”, manufactured by TOYO INK MFG. CO., LTD., solid content concentration of 37.5% by mass), 70 parts by mass of an urethane acrylate based oligomer (trade name “UV-2250EA”, manufactured by The Nippon Synthetic Chemical Industry Co., Ltd., weight average molecular weight of 10,000, solid content concentration of 30% by mass) as the energy ray polymerizable group-containing oligomer, and 1.0 parts by weight of 2-methyl-1-[4-(methylthio)phenyl]-2-morphorinopropane-1-one (trade name “IRGACURE 907” manufactured by Ciba Speciality Chemicals Inc.) as the photopolymerization initiator into 100 parts by mass of an acrylic ester copolymer resin (mass ratio of n-butyl acrylate /acrylic acid=90/10, weight average molecular weight of 700,000, solvent of tolune, solid content concentration of 40% by mass) as the base resin of the pressure-sensitive adhesive. Into the obtained mixture liquid, 170 parts by mass of the carbon nano tube-dispersing toluene solution prepared in (1) described above was formulated and mixed to prepare a pressure-sensitive adhesive composition. The content of the carbon nano tube was 4.7% by mass in the solid content of the pressure-sensitive adhesive composition.

(3) Preparation of a Pressure-Sensitive Adhesive Sheet

The pressure-sensitive adhesive composition prepared in (2) described above was applied on one surface of a substrate sheet composed of polyethylene terephthalate resin and having a thickness of 50 μm to form a pressure-sensitive adhesive layer having a dried thickness of 15 μm, and then dried to prepare a pressure-sensitive adhesive sheet.

### Example 2

A pressure-sensitive adhesive composition was prepared in the same method as described in Example 1, except that 136 parts by mass of the carbon nano tube-dispersing toluene solution prepared in (1) described above was formulated and mixed instead of the formulated amount of the carbon nano tube-dispersing toluene solution in Example 1. The content of the carbon nano tube was 3.8% by mass in the solid content of the pressure-sensitive adhesive composition.

Also, a pressure-sensitive adhesive sheet was prepared in the same method as described in Example 1.

### Example 3

A pressure-sensitive adhesive composition was prepared in the same method as described in Example 1, except that 102 parts by mass of the carbon nano tube-dispersing toluene solution prepared in (1) described above was formulated and mixed instead of the formulated amount of the carbon nano tube-dispersing toluene solution in Example 1. The content of the carbon nano tube was 2.9% by mass in the solid content of the pressure-sensitive adhesive composition.

Also, a pressure-sensitive adhesive sheet was prepared in the same method as described in Example 1.

### Example 4

A pressure-sensitive adhesive composition was prepared in the same method as described in Example 1, except that 68 parts by mass of the carbon nano tube-dispersing toluene solution prepared in (1) described above was formulated and mixed instead of the formulated amount of the carbon nano tube-dispersing toluene solution in Example 1. The content of the carbon nano tube was 2.0% by mass in the solid content of the pressure-sensitive adhesive composition.

Also, a pressure-sensitive adhesive sheet was prepared in the same method as described in Example 1.

### Example 5

A pressure-sensitive adhesive composition was prepared in the same method as described in Example 1, except that 257 parts by mass of the carbon nano tube-dispersing toluene solution prepared in (1) described above was formulated and mixed instead of the formulated amount of the carbon nano tube-dispersing toluene solution in Example 1. The content of the carbon nano tube was 6.8% by mass in the solid content of the pressure-sensitive adhesive composition.

Also, a pressure-sensitive adhesive sheet was prepared in the same method as described in Example 1.

### Example 6

A pressure-sensitive adhesive composition was prepared in the same method as described in Example 1, except that 370 parts by mass of the carbon nano tube-dispersing toluene solution prepared in (1) described above was formulated and mixed instead of the formulated amount of the carbon nano tube-dispersing toluene solution. The content of the carbon nano tube was 9.2% by mass in the solid content of the pressure-sensitive adhesive composition.

Also, a pressure-sensitive adhesive sheet was prepared in the same method as described in Example 1.

### Comparative Example 1

A pressure-sensitive adhesive composition was prepared in the same method as described in Example 1, except that the carbon nano tube-dispersing toluene solution was not formulated. Also, a pressure-sensitive adhesive sheet was prepared in the same method as described in Example 1.

### Comparative Example 2

A pressure-sensitive adhesive composition was prepared in the same method as described in Example 1, except that the carbon nano tube-dispersing toluene solution was not prepared and 5 parts by mass of the carbon nano tube was formulated directly in the pressure-sensitive adhesive.

Also, a pressure-sensitive adhesive sheet was prepared in the same method as described in Example 1.

The dispersion property, the surface resistivity and the electrification voltage of the pressure-sensitive adhesive sheet prepared in Examples of the present invention and Comparative Example were shown in Table 1. The adhesive strength of the pressure-sensitive adhesive sheet prepared in Examples of the present invention and Comparative Example were shown in Table 2.

The dispersion property, the surface resistivity, the electrification voltage and adhesive strength were measured in the following methods and evaluated.

(1) Evaluation of Dispersion Property

The pressure-sensitive adhesive sheets having a size of 300 mm and 200 mm were observed by visual. The dispersion property was evaluated by the following standard.
good: The aggregation of the carbon nano tube was not observed.
bad: The aggregation of the carbon nano tube was observed. (2) Measurement of electrification voltage

The pressure-sensitive adhesive sheet having a size of 40 mm and 40 mm was set on an electric attenuation measuring device (trade name “STATIC HONESTMER” manufactured by SHISHIDO Company Co., Ltd.), and was rotated at 1,300 rpm. During the rotation, the voltage of 10 kV was applied on the surface of the pressure-sensitive adhesive. After 60 seconds, the electrification voltage was measured. The measured value was taken as the electrification voltage before ultraviolet ray irradiation.

The similar pressure-sensitive adhesive sheet was irradiated with ultraviolet ray from the surface of the substrate sheet 10 times in the condition of conveyer speed of 10 m/min (integrated quantity of light of 1,000 mJ/cm²) by using belt conveyer type ultraviolet ray irradiating device equipped with one lamp of fusion H valve of 240 W/cm. After the irradiation of ultraviolet ray, the electrification voltage of the pressure-sensitive adhesive sheet was measured in the same method described above.

(3) Measurement of Surface Resistivity

The pressure-sensitive adhesive sheet having a size of 100 mm and 100 mm was set on an electrical resistance meter (trade name “R8252 ELECTROMETER” manufactured by ADVANTEST CORPORATION), and the surface resistivity on the surface of pressure-sensitive adhesive of the pressure-sensitive adhesive sheet was measured. The measured value was taken as the surface resistivity before ultraviolet ray irradiation.

The similar pressure-sensitive adhesive sheet was irradiated with ultraviolet ray from the surface of the substrate sheet 10 times in the condition of conveyer speed of 10 m/min (integrated quantity of light of 1,000 mJ/cm²) by using belt conveyer type ultraviolet ray irradiating device equipped with one lamp of fusion H valve of 240 W/cm. After the irradiation of ultraviolet ray, the surface resistivity of the pressure-sensitive adhesive sheet was measured in the same method described above.

TABLE 1

| | | Surface resistivity | | Electrification | |
|---|---|---|---|---|---|
| | | (Ω/□) | | voltage (kV) | |
| | Dispersion | before UV | after UV | before UV | after UV |
| | property | irradiation | irradiation | irradiation | irradiation |
| Example 1 | good | 4.0 × 10¹¹ | 1.8 × 10⁸ | 1.32 | 0.01 |
| Example 2 | good | 4.7 × 10¹¹ | 3.4 × 10⁸ | 1.44 | 0.01 |
| Example 3 | good | 8.0 × 10¹² | 5.6 × 10⁹ | 1.85 | 0.02 |
| Example 4 | good | 1.9 × 10¹⁵ | 2.9 × 10¹² | 2.00 | 1.43 |
| Example 5 | good | 2.5 × 10¹⁰ | 2.4 × 10⁷ | 1.03 | 0.01 |
| Example 6 | good | 4.2 × 10⁹ | 2.3 × 10⁶ | 0.77 | 0.01 |
| Comparative | — | 3.4 × 10¹⁶ | 5.8 × 10¹⁵ | 2.21 | 2.34 |
| Example 1 | | | | | |
| Comparative | bad | 3.1 × 10¹⁶ | 4.1 × 10¹⁶ | 2.12 | 2.24 |
| Example 2 | | | | | |

(4) Measurement of Adhesive Strength

The pressure-sensitive adhesive sheets prepared in above-described Examples and Comparative Example were stuck on a surface (mirror surface) of a silicon wafer having a diameter of 8 inch and a thickness of 600 μm. And, the adhesive strength of 180 degree peeling (adhesive strength before UV irradiation) was measured according to JIS Z0237. By the similar method, the pressure-sensitive adhesive sheets were stuck on the silicon wafer. And then, the pressure-sensitive adhesive sheet was irradiated with ultraviolet ray from the surface of the substrate sheet in the condition of conveyer speed of 10 m/min (integrated quantity of light of 1,000 mJ/cm2 ) by using belt conveyer type ultraviolet ray irradiating device equipped with one lamp of fusion H valve of 240 W/cm. After the irradiation of ultraviolet ray, the pressure-sensitive adhesive sheets were allowed to stand for 30 minuets the adhesive strength of 180 degree peeling (adhesive strength after UV irradiation) was measured according to JIS Z0237.

(5) Wafer Dicing Test

The pressure-sensitive adhesive sheets prepared in above described Examples 1 to 6 were stuck on a back surface of a silicon wafer having a diameter of 8 inch and a thickness of 350 μm, and then, the dicing of the wafer were conducted in the following condition. After the dicing, the pressure-sensitive adhesive sheet was irradiated with ultraviolet ray from the surface of the substrate sheet in the condition of conveyer speed of 10 m/min (integrated quantity of light of 1,000 mJ/cm²) by using belt conveyer type ultraviolet ray irradiating device equipped with one lamp of fusion H valve of 240 W/cm. After the irradiation of ultraviolet ray, the chips obtained by the dicing were picked up. All pressure-sensitive adhesive sheets did not cause chip flying in the dicing process and could hold and fix the wafer and the chips. Further, after irradiating the ultraviolet ray, the chips could be easily picked up.

### Dicing Condition

Device: trade name “AWD-4008B” manufactured by TOKYO SEIMISTU CO., LTD.
Dicing blade: trade name “NBC-ZH2050 2HECC” manufactured by DISCO Corporation
Number of rotation of blade: 30,000 rpm
Dicing speed: 100 mm/sec
Dicing size (chip size): 10 mm and 10 mm
Cut mode: down cut

TABLE 2

Adhesive strength
(mN/25 mm)

| | before UV | after UV |
|---|---|---|
| | irradiation | irradiation |
| Example 1 | 9800 | 175 |
| Example 2 | 11000 | 175 |
| Example 3 | 10800 | 160 |
| Example 4 | 11200 | 160 |
| Example 5 | 9600 | 205 |
| Example 6 | 9000 | 215 |
| Comparative | 15700 | 150 |
| Example 1 | | |
| Comparative | 9300 | 120 |
| Example 2 | | |

The pressure-sensitive adhesive composition of the present invention is superior in the antistatic property or the conductive property and therefore can be used in various uses in which the antistatic property or the conductive property is required. Also, the pressure-sensitive adhesive sheet of the present invention can be used in various uses in which the antistatic property or the conductive property are required, and particularly, can be preferably utilized as the dicing sheets for semiconductor wafer and the like and the surface protecting sheets for semiconductor wafer and the like.

1. A pressure-sensitive adhesive composition, which comprises a pressure-sensitive adhesive, a carbon nano material and a dispersing agent, the carbon nano material being dispersed with the dispersing agent in the pressure-sensitive adhesive.

2. The pressure-sensitive adhesive composition as claimed in claim 1, wherein the carbon nano material has an average peripheral size of 1 to 1,000 nm and an average length of 10 nm to 100 μm.

3. The pressure-sensitive adhesive composition as claimed in claim 1, wherein the dispersing agent is a polymer having an ether skeleton structure.

4. The pressure-sensitive adhesive composition as claimed in claim 1, wherein the pressure-sensitive adhesive composition comprises further an energy ray polymerizable group-containing compound.

5. The pressure-sensitive adhesive composition as claimed in claim 4, wherein the pressure-sensitive adhesive composition comprises furthermore a photopolymerization initiator.

6. The pressure-sensitive adhesive composition as claimed in claim 1, wherein the carbon nano material is comprised in the ratio of 0.05 to 15% by mass in a solid content of the pressure-sensitive adhesive composition.

7. A pressure-sensitive adhesive sheet, which comprises a substrate sheet and a pressure-sensitive adhesive layer composed of the pressure-sensitive adhesive composition as claimed in claim 1, the pressure-sensitive adhesive layer being formed on one surface or both surfaces of the substrate sheet.

8. The pressure-sensitive adhesive sheet as claimed in claim 7, wherein the pressure-sensitive adhesive sheet is a pressure-sensitive adhesive sheet for a semiconductor wafer processing.
